(19) United States
(12) Patent Application Publication
(10) Pub. No.: US 2025/0051597 A1
(43) Pub. Date: Feb. 13, 2025

(54) INK JET RECORDING METHOD AND INK JET RECORDING APPARATUS

(71) Applicant: CANON KABUSHIKI KAISHA, Tokyo (JP)

(72) Inventors: SOICHI NAGAI, Kanagawa (JP); YUKO NISHIWAKI, Tokyo (JP); ERIKO YOSHINO, Kanagawa (JP); ATSUHITO YOSHIZAWA, Tokyo (JP)

(21) Appl. No.: 18/796,709

(22) Filed: Aug. 7, 2024

(30) Foreign Application Priority Data
Aug. 7, 2023 (JP) 2023-128300
Jul. 23, 2024 (JP) 2024-117455

(51) Int. Cl. C09D 11/322; B41J 2/175; B41J 2/21; C09D 11/38; C09D 11/40

(52) U.S. Cl. CPC C09D 11/322; B41J 2/17513; B41J 2/2107; C09D 11/38; C09D 11/40

(57) ABSTRACT

Provided is an ink jet recording method with which, even when an ink jet recording apparatus having mounted thereon a recording unit in a form in which a recording head is incorporated into an ink storage portion is used and an aqueous ink containing a pigment is used, while the strength of the recording unit is maintained, an intermittent ejection stability of the aqueous ink is less liable to be reduced and an image excellent in light fastness can be recorded. The ink jet recording method includes recording an image through use of an ink jet recording apparatus including an aqueous ink, an ink storage portion, and a recording head. The ink storage portion includes three or more storage parts, and the storage parts are arrayed in one predetermined direction. A magenta ink containing a quinacridone pigment is stored in the storage part arranged on an inner side.

### BACKGROUND OF THE INVENTION

### Field of the Invention

The present invention relates to an ink jet recording method and an ink jet recording apparatus.

### Description of the Related Art

In recent years, there is an increasing demand for an ink jet recording apparatus for household use due to an increase of remote work at home and the like. Further, for household use, the ink jet recording apparatus is desired to be further downsized. For downsizing of the ink jet recording apparatus, downsizing of a recording head and an ink storage portion is essential. For example, there is known an ink jet recording apparatus having mounted thereon a recording unit downsized by integrating the ink storage portion and the recording head with each other.

Some of those ink jet recording apparatus adopt a recording head employing a system of ejecting ink by an action of thermal energy from the viewpoint that the ink jet recording apparatus can be designed to be more downsized. Further, the recording head has been devised to be downsized by providing ejection orifice arrays for ejecting respective inks of a plurality of colors in the same recording element substrate. Moreover, some recording units are downsized by bonding the recording head to the ink storage portion without intermediation of any other member. In addition, the apparatus is downsized by forming the ink storage portion from a thermoplastic resin to reduce the weight of the recording unit, and decreasing the rigidity required for a carriage portion.

However, the ink storage portion formed from only a thermoplastic resin has problems of being liable to be deformed and being liable to crack due to an external pressure such as an impact applied by falling. In order to solve such problems, there has been proposed an ink storage container formed from a material obtained by adding a filler material such as a glass filler to a thermoplastic resin so that a linear expansion coefficient is reduced (Japanese Patent Application Laid-Open No. 2008-142935). In a case of an ink jet recording apparatus assumed to output also documents for use in business such as remote work at home, there has been a demand for a high level of permanence even for a color image, and hence a pigment ink using a pigment as a coloring material has been suitably used.

The inventors of the present invention have verified the ink storage portion formed from a thermoplastic resin composition containing a filler material, which has been proposed in Japanese Patent Application Laid-Open No. 2008-142935. Specifically, an ink jet recording apparatus having mounted thereon a recording unit formed by bonding a recording head to this ink storage portion (hereinafter also simply referred to as “recording unit”) was prepared. Then, an image was recorded through use of the above-mentioned ink jet recording apparatus in which an aqueous ink containing a pigment was stored in the ink storage portion. As a result, a phenomenon as described below occurred in a magenta ink containing a quinacridone pigment, and it was found that an intermittent ejection stability was reduced. That is, when no ink is ejected for a long time period from some ejection orifices of the recording head and no recovery operation of the recording head is performed, a liquid component such as water in the ink evaporates from the ejection orifice to cause thickening of the ink and sticking of the ink to a nozzle. After that, when the ink is attempted to be re-ejected from the ejection orifice, the ejection of the first shot of the ink may become unstable or no ink may be ejected, resulting in that the image may be easily distorted.

As a result of further verification, it was found that, when a dye ink containing a dye as a coloring material was used, reduction of the intermittent ejection stability to a level caused in the pigment ink did not occur. Further, the inventors of the present invention prepared an ink storage portion formed from a thermoplastic resin containing no filler material. Then, an ink jet recording apparatus having mounted thereon a recording unit obtained by bonding a recording head to this ink storage portion was used. As a result, it was found that the intermittent ejection stability did not reduce even when an aqueous ink containing a pigment was used.

### SUMMARY OF THE INVENTION

Thus, the present invention has an object to solve problems caused when a recording apparatus having mounted thereon a recording unit in a form in which a recording head is incorporated into an ink storage portion formed from a thermoplastic resin composition containing a filler material is used and an aqueous ink containing a pigment is used. That is, the present invention has an object to provide an ink jet recording method in which an intermittent ejection stability of an aqueous ink containing a pigment is less liable to be reduced and an image excellent in light fastness can be recorded, while maintaining a strength of a recording unit even when such a downsized recording apparatus is used. Further, the present invention has another object to provide an ink jet recording apparatus to be used in this ink jet recording method.

That is, according to the present invention, there is provided an ink jet recording method using an ink jet recording apparatus, the ink jet recording apparatus including: an aqueous ink containing a pigment; an ink storage portion which is configured to store the aqueous ink, and is formed from a thermoplastic resin composition containing a filler material; and a recording head to be bonded to the ink storage portion, the recording head having formed therein an ejection orifice configured to eject the aqueous ink supplied from the ink storage portion, the ink jet recording method including recording an image by applying the aqueous ink ejected from the ejection orifice to a recording medium. The ink storage portion includes three or more storage parts divided independently of each other, and the three or more storage parts are arrayed in one predetermined direction. The aqueous ink includes a magenta ink containing a quinacridone pigment. The magenta ink is stored in a corresponding one of the three or more storage parts arranged on an inner side.

According to the present invention, it is possible to solve problems caused when the ink jet recording apparatus having mounted thereon the recording unit in a form in which the recording head is incorporated into the ink storage portion formed from the thermoplastic resin composition containing the filler material is used and the aqueous ink containing the pigment is used. That is, it is possible to provide the ink jet recording method in which an intermittent ejection stability of the aqueous ink containing the pigment is less liable to be reduced and an image excellent in light fastness can be recorded, even when such a downsized recording apparatus is used. Further, according to the present invention, it is possible to provide the ink jet recording apparatus to be used in this ink jet recording method.

Further features of the present invention will become apparent from the following description of exemplary embodiments with reference to the attached drawings.

### BRIEF DESCRIPTION OF THE DRAWINGS

FIG. 1 is a perspective view for schematically illustrating an ink jet recording apparatus according to one embodiment of the present invention.

FIG. 2 is a perspective view for schematically illustrating an internal structure of the ink jet recording apparatus according to one embodiment of the present invention.

FIG. 3 is a view for schematically illustrating an example of a recording unit. (a) is a perspective view, and (b) is a perspective view of an exploded state.

FIG. 4 is a view for schematically illustrating an example of the recording unit. (a) is a view as viewed from above with a tank lid being removed, and (b) is a view as viewed from below.

FIG. 5 is a view for schematically illustrating another example of the recording unit. (a) is a view as viewed from above with the tank lid being removed, and (b) is a view as viewed from below.

FIG. 6 is a schematic view for illustrating an example of a sucking unit.

FIG. 7A is a schematic view for illustrating an example of an array mode of storage parts.

FIG. 7B is a schematic view for illustrating another example of the array mode of the storage parts.

FIG. 7C is a schematic view for illustrating another example of the array mode of the storage parts.

FIG. 7D is a schematic view for illustrating another example of the array mode of the storage parts.

FIG. 7E is a schematic view for illustrating another example of the array mode of the storage parts.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink for ink jet is sometimes simply referred to as “ink”. Physical property values are values at normal temperature (25° C.) unless otherwise stated.

The inventors of the present invention have verified causes of reduction of the intermittent ejection stability of a specific ink in a case of using an ink jet recording apparatus having mounted thereon a recording unit in a form in which a recording head is incorporated into an ink storage portion formed from a thermoplastic resin composition containing a filler material.

The recording unit in the form in which the recording head is incorporated into the ink storage portion formed from the thermoplastic resin composition containing the filler material is normally stored under a state in which the ink storage portion is filled with the ink, and the recording unit is set to the ink jet recording apparatus at the time of starting usage of the apparatus. As a result of the verification, it was found that an inorganic metal, such as calcium (Ca), magnesium (Mg), iron (Fe) and aluminum (Al), was liable to be eluted from the filler material during storage to be dissolved into the ink. Further, when a pigment ink containing a resin is used, pH of the ink is sometimes set to be high in order to suppress precipitation of the resin. However, it was found that the inorganic metal was more liable to be dissolved in the ink for which pH is set to be high. It is considered that, when the inorganic metal is dissolved in the ink, a dispersion state of the pigment is liable to become unstable and thus the intermittent ejection stability is reduced. In this case, when a dye ink was used, no reduction of the intermittent ejection stability was observed. The reason therefor is considered to be because a dye ink is less liable to become unstable even when an inorganic metal is dissolved therein.

It cannot be said that a gas barrier property of the ink storage portion formed from the thermoplastic resin composition containing the filler material is always high. Accordingly, the following can also be considered as causes of reduction of the intermittent ejection stability. That is, a liquid component such as water in the ink stored in the ink storage portion gradually evaporates so that the concentration of the pigment in the ink relatively increases. Thus, the dispersion state of the pigment becomes unstable, or the sedimentation of the pigment may be promoted.

Further, a quinacridone pigment has a planar structure, and thus has a large attracting area and a strong hydrogen bonding property obtained by a plurality of amide groups. Thus, the pigment particles tend to strongly stack on each other. Accordingly, the binding force of the quinacridone pigment is stronger than that of a phthalocyanine pigment or an azo pigment. In addition, as a result of further verification, it was found that the intermittent ejection stability remarkedly reduced due to evaporation of a liquid component such as water in the ink.

As a result of the verification, the inventors of the present invention produced an ink storage portion which included three or more storage parts divided independently of each other and in which those storage parts were arrayed in one predetermined direction. In addition, a cyan ink, a magenta ink and a yellow ink were stored in the respective storage parts arrayed in one row, and the ink storage portion was left under the conditions that easily cause evaporation of the ink. After that, evaluation of the intermittent ejection stability was carried out. As a result of those verifications, the inventors of the present invention have found that the reduction of the intermittent ejection stability of the ink may be suppressed by storing the magenta ink containing the quinacridone pigment in a storage part arranged on an inner side. Thus, the present invention has been made. When three or more storage parts are arrayed in one direction, water moves from each of the storage parts arranged on both sides to the storage part arranged on the inner side, and the content of water in the ink stored in the storage part arranged on the inner side is slightly increased (is humidified). Further, the storage part arranged on the inner side has a relatively small contact area with external air, and hence the water in the stored ink is less liable to evaporate as compared to the storage parts arranged on both sides. In addition, when the magenta ink containing the quinacridone pigment that is more liable to aggregate is stored in the storage part arranged on the inner side, it is considered that the intermittent ejection stability of the magenta ink can be improved.

### <Ink Jet Recording Method and Ink Jet Recording Apparatus>

The ink jet recording method of the present invention is a recording method using an ink jet recording apparatus including an ink containing a pigment, an ink storage portion for storing the ink, and a recording head bonded to the ink storage portion. The ink storage portion is formed from a thermoplastic resin composition containing a filler material. In the recording head, an ejection orifice for ejecting the ink supplied from the ink storage portion is formed. In addition, the ink jet recording method of the present invention includes a step of recording an image by applying the ink ejected from the ejection orifice to a recording medium. The ink storage portion includes three or more storage parts divided independently of each other, and those storage parts are arrayed in one predetermined direction. In addition, the ink includes a magenta ink containing a quinacridone pigment, and this magenta ink is stored in the storage part arranged on the inner side.

Further, the ink jet recording apparatus of the present invention is an ink jet recording apparatus including an ink containing a pigment, an ink storage portion for storing the ink, and a recording head bonded to the ink storage portion. The ink storage portion is formed from a thermoplastic resin composition containing a filler material. In the recording head, an ejection orifice for ejecting the ink supplied from the ink storage portion is formed. The ink storage portion includes three or more storage parts divided independently of each other, and those storage parts are arrayed in one predetermined direction. In addition, the ink includes a magenta ink containing a quinacridone pigment, and this magenta ink is stored in the storage part arranged on the inner side.

### (Ink Jet Recording Apparatus)

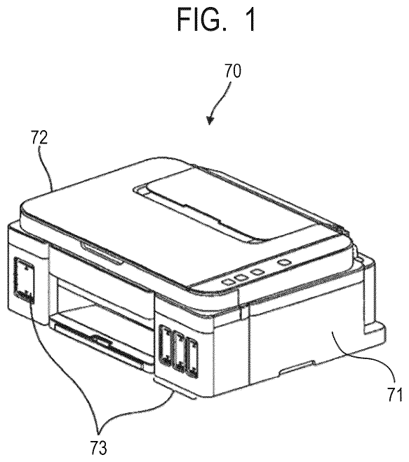

FIG. 1 is a perspective view for schematically illustrating an ink jet recording apparatus according to one embodiment of the present invention. As illustrated in FIG. 1, an ink jet recording apparatus 70 of this embodiment includes an outer package 71 and a cover member 72 arranged on the upper surface of the outer package 71. The cover member 72 is a member that is openable and closable in a vertical direction, and its opening in an upper direction enables the observation of the inside of the ink jet recording apparatus 70 having a rectangular parallelepiped shape.

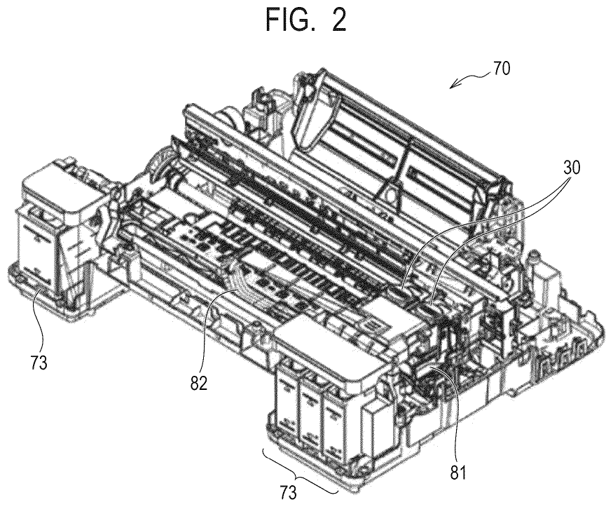

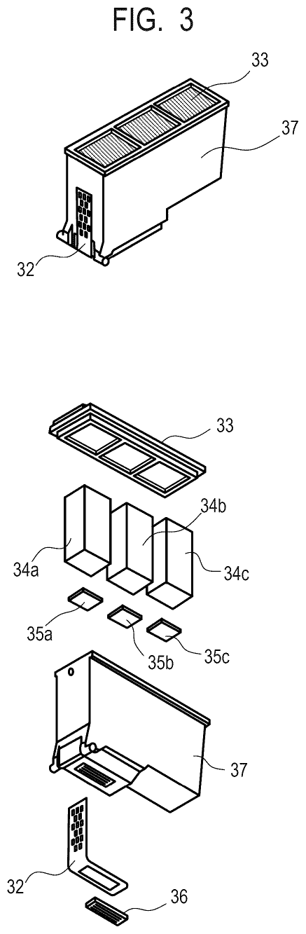

FIG. 2 is a perspective view for schematically illustrating the internal structure of the ink jet recording apparatus according to one embodiment of the present invention. A recording unit 30 in which a recording head and an ink storage portion are integrally formed is configured to be mountable to a carriage (support member) 81. The recording unit 30 is provided on the carriage by being coupled to a joint (not shown) provided at an upper portion of the carriage 81. The recording unit 30 is coupled to a tube 82 which is a flexible member, and another end of the tube 82 is coupled to a main tank (second ink storage portion) 73 which is a second ink storage portion. When the recording unit 30 is mounted to the carriage 81, a recording head 36 ((b) in FIG. 3) is allowed to communicate with the main tank 73 via the joint and the tube 82. The ink jet recording apparatus 70 of this embodiment is a recording apparatus of a serial scan type, and the carriage 81 is guided to be movable in a main scanning direction by a guide shaft. The carriage 81 reciprocates in the main scanning direction by a carriage motor and a drive force transmission mechanism such as a belt for transmitting a drive force of the carriage motor (both not shown).

A recording medium is conveyed by a conveyance roller in a sub-scanning direction orthogonal to the main scanning direction of the carriage 81. The ink jet recording apparatus 70 repeatedly performs a recording operation of ejecting an ink toward a recording region of the recording medium on a platen while moving the recording head 36 ((b) in FIG. 3) in the main scanning direction, and a conveying operation of conveying the recording medium in the sub-scanning direction by a distance corresponding to its recording width. In this manner, an image is sequentially recorded on the recording medium.

FIG. 3 is a view for schematically illustrating an example of the recording unit. (a) is a perspective view, and (b) is a perspective view of an exploded state. The recording unit illustrated in FIG. 3 includes an ink storage portion 37 and the recording head 36. The ink storage portion 37 is a casing formed from a thermoplastic resin composition containing a filler material. Examples of the thermoplastic resin composition include polyester, polycarbonate, polypropylene, polyethylene, polystyrene, polyphenylene ether and mixtures or modified substances of them. Examples of the filler material include a flake filler such as mica and a fibrous filler such as a glass fiber. A general glass fiber is a glass fiber (chopped strand) made of a material called E-glass (non-alkali glass) in a form of being cut into a predetermined length. The recording head 36 is preferably bonded to the ink storage portion 37 without through intermediation of any other member. The ink storage portion 37 has a light weight because the portion is a casing formed from a thermoplastic resin composition. The entirety of the recording unit is reduced in size and weight because the recording head 36 is bonded to the ink storage portion 37 without through intermediation of any other member such as a heat-radiating plate. The use of such recording unit can reduce the size and weight of the entirety of the ink jet recording apparatus. The heat-radiating plate may be, for example, a plate formed from a material such as a metal oxide such as alumina. Further, the ink storage portion 37 formed from the thermoplastic resin composition containing the filler material has a linear expansion coefficient lower than that of a member formed from a thermoplastic resin containing no filler material. Accordingly, deformation of the casing can be suppressed, and occurrence of cracking due to an external pressure such as falling can be suppressed.

The recording head 36 has arranged therein, for example, a plurality of ejection orifices that ejects the ink and an energy-generating element that generates energy for ejecting the ink. The energy-generating element and the like may be driven by, for example, electric power supplied through an electrical wiring member 32. The energy-generating element is an element that generates thermal energy or mechanical energy, and the action of the generated energy can eject the ink from the ejection orifices. Examples of the element that generates thermal energy include an electrothermal converter. Examples of the element that generates mechanical energy include a piezoelectric element. Of those, a recording head that ejects the ink by the action of the thermal energy is preferable because the recording head can be designed to be downsized.

The recording head 36 includes an ejection orifice surface in which a plurality of ejection orifice arrays each formed of a plurality of ejection orifices is arrayed in the same recording element substrate. When the plurality of ejection orifice arrays is arrayed in the same recording element substrate, a plurality of inks can be ejected by one recording unit, and thus the ink jet recording apparatus can be downsized. The plurality of ejection orifice arrays is preferably arrayed in a direction (sub-scanning direction) orthogonal to a reciprocating direction (main scanning direction) of the recording unit into which the recording head is incorporated. Further, with the ejection orifice array being formed of the plurality of ejection orifices, a recordable region at the time of reciprocating the recording head can be enlarged, and hence fast recording can be performed.

Sponge-like ink absorbers 34a to 34c are stored in the ink storage portion 37. In addition, filters 35a to 35c are arranged below the ink storage portion 37 in a gravity direction. When a negative pressure is generated by utilizing the capillary forces of the sponge-like ink absorbers 34a to 34c, the ink can be prevented from leaking from the ejection orifices. In addition, the arrangement of the filters 35a to 35c can suppress the entry of fine foreign matter such as dirt into the ejection orifices. Further, provision of a tank lid 33 by thermocompression bonding on an upper side of the ink storage portion 37 in the gravity direction can prevent the ink from leaking from the ink storage portion 37.

The recording head preferably includes a warming unit for warming the ink in the recording head. The warming unit only needs to be a unit that can warm the ink in the recording head to a temperature higher than a recording environment temperature such as a room temperature (25° C.). Examples of such warming unit may include: a heater for ink temperature control arranged so as to be brought into contact with the recording head; and a heater for ink ejection. To warm the ink with the heater for ink ejection, for example, such a current that the ink is not ejected can be repeatedly passed through the heater.

The ink jet recording apparatus further preferably includes a second ink storage portion and a tube. The second ink storage portion such as a main tank has a capacity larger than that of the ink storage portion (first ink storage portion) such as a sub tank. The tube allows the ink to flow between the second ink storage portion and the ink storage portion. In consideration of a usage mode or the like in remote work at home, reduction in replacement frequency of an ink cartridge is also important in addition to downsizing of the apparatus. Accordingly, further provision of the second ink storage portion such as the main tank can reduce the ink replacement frequency while the increase in size of the apparatus main body is avoided. In the following, an ink jet recording apparatus in which only the first ink storage portion such as the sub tank bonded to the recording head is provided as the ink storage portion is also referred to as “first apparatus configuration.” In the case of the first apparatus configuration, when the ink stored inside of the ink storage portion has been consumed, the ink storage portion is replaced with another ink storage portion (ink storage portion filled with an ink). Thus, as compared to a second apparatus configuration, the main tank and the tube can be omitted, and thus the weight of the ink jet recording apparatus can be reduced. Further, an ink jet recording apparatus in which the second ink storage portion such as the main tank having a capacity larger than that of the sub tank is further provided as the ink storage portion is also referred to as “second apparatus configuration.” In the case of the second apparatus configuration, for example, when a connection portion for a tube is formed in the tank lid 33 illustrated in FIG. 3, the ink storage portion 37 and the second ink storage portion such as the main tank can be connected to each other.

In the case of the second apparatus configuration, the ink replacement frequency is reduced as compared to the first apparatus configuration, and hence a period in which an ink in a stationary state is kept in the main tank becomes long. Further, in a case of a pigment ink, when the period in which the ink is kept in the stationary state becomes long, the pigment is liable to be settled. Degradation of an ejection property caused by sticking occurs because the ink dries in the flow path and the pigment aggregates. Thus, the degradation of the ejection property becomes more remarkable as an ink having a larger content of the pigment is used. In addition, depending on the usage state, the intermittent ejection stability of the second apparatus configuration is often lower than the intermittent ejection stability of the first apparatus configuration. In particular, the intermittent ejection stability is liable to remarkedly reduce in an ink containing the quinacridone pigment. Meanwhile, in the ink jet recording method of the present invention, both of the reduction in ink replacement frequency and the improvement in intermittent ejection stability can be achieved.

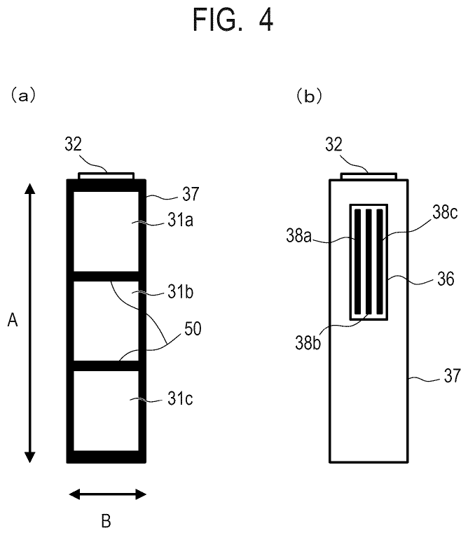

FIG. 4 is a view for schematically illustrating an example of the recording unit. (a) is a view as viewed from above with the tank lid being removed, and (b) is a view as viewed from below (recording head side). As illustrated in FIG. 4, the ink storage portion 37 includes three or more storage parts 31a to 31c divided independently of each other. Those storage parts 31a to 31c are divided by, for example, partition portions 50 formed from the same material as the casing, and are capable of individually storing a plurality of kinds of inks. Further, the recording head 36 includes an ejection orifice surface in which a plurality of ejection orifice arrays 38a to 38c each formed of a plurality of ejection orifices is arrayed in the same recording element substrate. Those ejection orifice arrays 38a to 38c correspond to the plurality of kinds of inks individually stored in the storage parts 31a to 31c, respectively. In addition, the storage parts 31a to 31c are arrayed in one predetermined direction, and the magenta ink containing the quinacridone pigment is stored in the storage part 31b arranged on the inner side among the storage parts 31a to 31c. The storage part 31b arranged on the inner side has a relatively small contact area with the external air, and hence water is less liable to evaporate from the stored magenta ink as compared to the storage parts 31a and 31c arranged on both sides. Further, water moves from each of the storage parts 31a and 31c arranged on both sides to the storage part 31b arranged on the inner side, and hence the content of water in the magenta ink stored in the storage part 31b is slightly increased (is humidified). In this manner, it is considered that the intermittent ejection stability of the magenta ink stored in the storage part 31b can be improved.

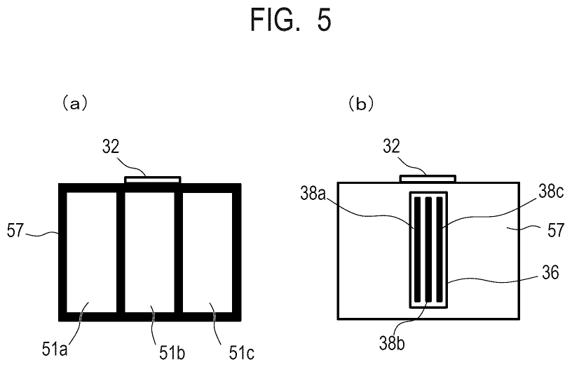

FIG. 5 is a view for schematically illustrating another example of the recording unit. (a) is a view as viewed from above with the tank lid being removed, and (b) is a view as viewed from below (recording head side). An ink storage portion 57 illustrated in FIG. 5 includes three or more storage parts 51a to 51c divided independently of each other, and those storage parts 51a to 51c are arrayed in one predetermined direction. An array direction of the plurality of storage parts only needs to be one direction in a predetermined direction. For example, the storage parts may be arrayed in a direction orthogonal to the main scanning direction of the recording head 36 as illustrated in FIG. 4, or may be arrayed in a direction parallel to the main scanning direction of the recording head 36 as illustrated in FIG. 5. From the viewpoint of the strength of the ink storage portion, the array direction of the plurality of storage parts is particularly preferably the array direction orthogonal to the main scanning direction of the recording head 36.

In the ink storage portion, a ratio (A/B) of a length A in a longitudinal direction (sub-scanning direction) to a length B in a transverse direction (main scanning direction) is preferably 2.0 times or more to 4.0 times or less ((a) in FIG. 4). When the ratio A/B is set to 2.0 times or more, a compact apparatus width can be achieved. In order to record an image on the entire surface of the recording medium through use of a so-called serial type ink jet recording apparatus in which the image is recorded while the recording head scans back and forth in the main scanning direction orthogonal to the conveying direction of the recording medium, it is required to move the ejection orifice array from one end to another end of the recording medium. When the width of the recording head is wide, the width of the ink jet recording apparatus becomes inevitably wide. Further, in a case in which the ratio A/B of the ink storage portion is excessively large, when an external force is applied to the casing, the stress concentrates in the longitudinal direction, and, in some cases, deformation due to the insufficient strength of the casing may occur. Accordingly, the ratio A/B is preferably 4.0 times or less.

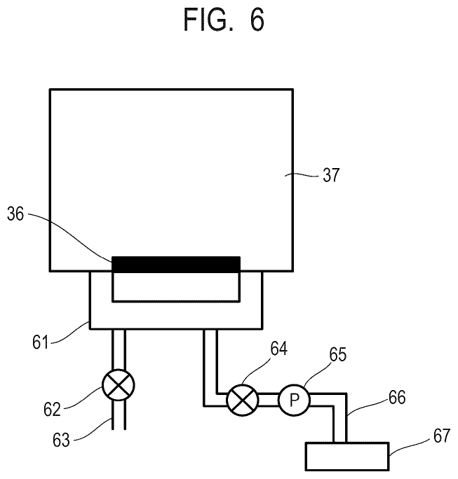

FIG. 6 is a schematic view for illustrating an example of a sucking unit. As illustrated in FIG. 6, the ink jet recording apparatus includes a cap 61 for covering the plurality of ejection orifice arrays in abutment against a region including the ejection orifice surface of the recording head 36. A tube 63 and a waste ink tube 66 are connected to the cap 61. The tube 63 functions as an atmosphere communicating portion, and the waste ink tube 66 discharges a waste ink not used for recording, which is accumulated in the cap 61. In the middle of the tube 63, an atmosphere communicating valve 62 is provided. The waste ink discharged from the ejection orifice of the recording head 36 is stored in a waste ink storage portion 67. A suction valve 64 is provided in the middle of the waste ink tube 66, and a sucking operation for discharging the unrequired waste ink is carried out through use of a pump 65. In this embodiment, description has been given of an example of a sucking operation in which the pump provided on a downstream side of the recording head is used, but the waste ink not used for recording may be discharged from the ejection orifice by a pressurizing operation using a pump provided on an upstream side of the recording head.

For example, when it becomes difficult to normally eject an ink because the ink dries and sticks in a flow path or the like communicating with the ejection orifice, the sucking operation is carried out to cause a new ink to flow from the ink storage portion 37. Thus, the state in which the normal ejection is difficult can be solved. Normally, when the plurality of ejection orifice arrays is arrayed in the same recording element substrate, the sucking operation is carried out with the same cap. For example, when the ejection orifice arrays for respectively ejecting a cyan ink, a magenta ink and a yellow ink are arrayed in the same recording element substrate, those inks are collectively sucked with the same cap. In general, when an ink for which sticking can be easily solved and an ink for which sticking cannot be easily solved are mixed, although the sticking of the ejection orifice for ejecting the ink for which sticking can be easily solved is solved, the sucking operation for the ink for which sticking cannot be easily solved needs to be continued. In addition, in some cases, a waste ink amount of an ink having a low intermittent ejection stability is liable to increase.

### (Aqueous Ink)

In the ink jet recording method of the present invention, an ink containing a pigment is used. The method includes a step of recording an image by applying the ink ejected from an ejection orifice to a recording medium. The ink includes a magenta ink. In addition, the ink, typically, further contains an ink having a hue except magenta. Examples of the ink having a hue except magenta may include a cyan ink and a yellow ink. Now, components for forming the ink and the like are described. When there is no need to distinguish the cyan ink, the magenta ink and the yellow ink from each other, the inks are collectively referred to as “ink.” The inks of the respective colors may have the same configuration or have different configurations within a range of the preferable mode described below.

### [Coloring Material]

As a coloring material of the ink, a pigment is used from the viewpoint of improving the permanence of the image. In the three or more storage parts arrayed in one predetermined direction, a quinacridone pigment needs to be used in a magenta ink stored in the storage part arranged on the inner side.

Examples of the pigment may include organic pigments, such as an azo pigment, a phthalocyanine pigment, a quinacridone pigment, an isoindolinone pigment, an imidazolone pigment, a diketopyrrolopyrrole pigment and a dioxazine pigment. A pigment of the magenta ink is preferably, for example, a quinacridone pigment, an azo pigment or a diketopyrrolopyrrole pigment. A pigment of any other ink (e.g., a cyan ink or a yellow ink) that may be used together with the magenta ink is preferably, for example, a phthalocyanine pigment, an isoindolinone pigment, an imidazolone pigment or a dioxazine pigment.

The content (% by mass) of the pigment in the ink is preferably 0.50% by mass or more to 10.00% by mass or less, more preferably 1.00% by mass or more to 8.00% by mass or less with respect to the total mass of the ink.

The ink contains a magenta ink containing a quinacridone pigment. The content (% by mass) of the quinacridone pigment in the magenta ink is preferably 5.00% by mass or less, more preferably 0.50% by mass or more to 4.00% by mass or less with respect to the total mass of the magenta ink.

The magenta ink preferably further contains a non-quinacridone pigment which is a pigment other than the quinacridone pigment. Through use of the magenta ink containing the non-quinacridone pigment, the intermittent ejection stability can be more improved. In addition, the content (% by mass) of the quinacridone pigment in the magenta ink is preferably 1.0 times or more to 8.0 times or less in terms of a mass ratio with respect to the content (% by mass) of the non-quinacridone pigment. In this range, the mass ratio is preferably 1.5 times or more to 4.0 times or less, more preferably 2.0 times or more to 6.0 times or less. When the above-mentioned mass ratio is less than 1.5 times, in some cases, a light fastness of the recorded image is slightly reduced. When the above-mentioned mass ratio is more than 4.0 times, in some cases, the intermittent ejection stability is slightly reduced. Examples of the non-quinacridone pigment that can be contained in the magenta ink may include an azo pigment and a diketopyrrolopyrrole pigment.

Examples of a dispersion system for the pigment may include a resin-dispersed pigment using a resin (resin dispersant) as a dispersant and a self-dispersible pigment having a hydrophilic group bonded to its particle surface. In addition, a resin-bonded pigment having a resin-containing organic group chemically bonded to its particle surface, a microcapsule pigment whose particle surface is covered with, for example, a resin, or the like may be used. Of those, it is particularly preferable to use a resin-dispersed pigment using a resin dispersant having a hydrophobic portion and a hydrophilic portion so that the hydrophobic portion of the resin dispersant is adsorbed to the particle surface of the pigment and the pigment is dispersed by the hydrophilic portion.

A resin that can disperse the pigment in an aqueous medium through the action of an anionic group is preferably used as a resin dispersant. A water-soluble resin to be described later may be used as the resin dispersant. When the resin-dispersed pigment is used, the mass ratio of the content (% by mass) of the pigment in the ink to the content (% by mass) of the resin dispersant therein is preferably 0.3 times or more to 10.0 times or less.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

### [Resin]

A resin such as water-soluble resin may be incorporated into the ink. The content (% by mass) of the resin in the ink is preferably 0.10% by mass or more to 20.00% by mass or less, more preferably 0.50% by mass or more to 15.00% by mass or less with respect to the total mass of the ink. The resin may be added to the ink (i) for stabilizing the dispersed state of the pigment, that is, as a resin dispersant or an aid therefor. In addition, the resin may be added to the ink (ii) for improving the various characteristics of an image to be recorded. Examples of the form of the resin may include a block copolymer, a random copolymer, a graft copolymer and a combination thereof. The resin may be a water-soluble resin that can be dissolved in an aqueous medium or may be a resin particle to be dispersed in the aqueous medium.

Examples of the resin may include an acrylic resin, a urethane resin and an olefin resin. Of those, an acrylic resin and a urethane resin are preferred, and an acrylic resin is more preferred. The acrylic resin preferably has, as constituent units, a hydrophilic unit as a hydrophilic part and a hydrophobic unit as a hydrophobic part. The hydrophilic unit is a unit having a hydrophilic group such as an anionic group. The hydrophilic unit may be formed by, for example, polymerizing a hydrophilic monomer having a hydrophilic group. Examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

Of those, an acrylic resin including a hydrophilic unit derived from (meth)acrylic acid and a hydrophobic unit derived from at least one kind selected from the group consisting of a monomer having an aromatic ring and a (meth)acrylic acid ester-based monomer is preferred. In particular, an acrylic resin including a hydrophilic unit derived from (meth)acrylic acid and a hydrophobic unit derived from at least one of a styrene monomer or an α-methylstyrene monomer is preferred. Those acrylic resins can each be suitably used as a resin dispersant for dispersing the pigment because the resins each easily interact with the pigment.

The urethane resin may be obtained by, for example, causing a polyisocyanate and a polyol to react with each other. In addition, a chain extender may be further caused to react with the reaction product. Examples of the olefin resin may include polyethylene and polypropylene.

The phrase “resin is water-soluble” as used herein means that when the resin is neutralized with an alkali in an amount equivalent to its acid value, the resin is present in an aqueous medium under a state in which the resin does not form any particle whose particle diameter may be measured by a dynamic light scattering method. Whether or not a resin is water-soluble may be determined in accordance with a method described below. First, a liquid (resin solid content: 10% by mass) containing a resin neutralized with an alkali (e.g., sodium hydroxide or potassium hydroxide) equivalent to its acid value is prepared. Next, the prepared liquid is diluted 10-fold (based on a volume) with pure water to prepare a sample solution. Then, when the particle diameter of the resin in the sample solution is measured by a dynamic light scattering method, and a particle having a particle diameter is not measured, the resin may be determined to be water-soluble. Meanwhile, when a particle having a particle diameter is measured, the resin may be determined as “resin particle” (that is, “water dispersible resin”). Measurement conditions in this case may be set, for example, as described below.

### [Measurement Conditions]

Set Zero: 30 seconds
Number of times of measurement: three times
Measurement time: 180 seconds

A particle size analyzer based on a dynamic light scattering method (e.g., product name “UPA-EX150”, manufactured by Nikkiso Co., Ltd.) or the like may be used as a particle size distribution-measuring apparatus. The particle size distribution-measuring apparatus to be used, the measurement conditions and the like are of course not limited to the foregoing.

### [Aqueous Medium]

The ink is an aqueous ink containing an aqueous medium that is a mixed solvent of water and a water-soluble organic solvent. Deionized water (ion-exchanged water) is preferably used as the water. The content (% by mass) of the water in the ink is preferably 50.00% by mass or more to 95.00% by mass or less with respect to the total mass of the ink.

The ink to be stored in the ink storage portion described above includes, in addition to the magenta ink, normally, another ink other than the magenta ink, such as a cyan ink and a yellow ink. In addition, the content (% by mass) of water in the magenta ink is preferably lower than the content (% by mass) of water in the another ink. As described above, the magenta ink is stored in the storage part arranged on the inner side. In addition, a little amount of moisture in the another ink stored in each of the storage parts arranged adjacent thereto on both sides moves to the magenta ink stored in the storage part arranged on the inner side, and hence the moisture amount in the magenta ink is preferably adjusted to be slightly lower. In this manner, the intermittent ejection stability can be more improved.

Solvents that may be used in inks for ink jet, such as alcohols, glycols, (poly)alkylene glycols, nitrogen-containing compounds and sulfur-containing compounds, may each be used as the water-soluble organic solvent. The content (% by mass) of the water-soluble organic solvent in the ink is preferably 3.00% by mass or more to 50.00% by mass or less with respect to the total mass of the ink.

The magenta ink preferably further contains a first water-soluble organic solvent having a relative dielectric constant of 20.0 or more to 30.0 or less. Through use of the magenta ink containing the first water-soluble organic solvent, the intermittent ejection stability can be further improved. The content (% by mass) of the first water-soluble organic solvent in the magenta ink is preferably 10.00% by mass or more with respect to the total mass of the magenta ink, more preferably 12.00% by mass or more, and is preferably 30.00% by mass or less.

Examples of the first water-soluble organic solvent may include tetraethylene glycol (20.8), 1,2-butanediol (22.2), triethylene glycol (22.7), 1-(hydroxymethyl)-5,5-dimethylhydantoin (23.7), 3-methyl-1,5-pentanediol (23.9), 3-methyl-1,3-butanediol (24.0), 1,5-pentanediol (27.0), 2-pyrrolidone (28.0), 2-methyl-1,3-propanediol (28.3), 1,2,6-hexanetriol (28.5), propylene glycol (28.8) and 1,3-butanediol (30.0) (a numerical value in parentheses represents a relative dielectric constant at 25° C.). The first water-soluble organic solvent is preferably a first water-soluble organic solvent having a vapor pressure lower than that of water. Of the first water-soluble organic solvents, triethylene glycol is particularly preferable because the dispersed state of the quinacridone pigment may be easily kept stable.

The relative dielectric constant of the water-soluble organic solvent can be measured through use of a dielectric constant meter (e.g., product name “BI-870,” manufactured by Brookhaven Instruments Corporation, or the like) under a condition of a frequency of 10 kHz. The relative dielectric constant of the water-soluble organic solvent that is a solid at 25° C. is a value calculated from the following equation (A) after the measurement of the relative dielectric constant of a 50% by mass aqueous solution thereof. Although the “water-soluble organic solvent” typically is a liquid, in the present invention, a solvent that is a solid at 25° C. (normal temperature) is also included in the category of the water-soluble organic solvent.

εₛₒₗ=2ε_{50%}−ε_{water} (A)
εₛₒₗ: relative dielectric constant of the water-soluble organic solvent that is a solid at 25° C.
ε_{50%}: relative dielectric constant of a 50% by mass aqueous solution of the water-soluble organic solvent that is a solid at 25° C.
ε_{water}: relative dielectric constant of water

Examples of the water-soluble organic solvent that is generally used in the aqueous ink and is a solid at 25° C. may include 1,6-hexanediol, trimethylolpropane, ethylene urea, urea, polyethylene glycol having a number-average molecular weight of 1,000. Herein, the reason why the relative dielectric constant of the water-soluble organic solvent that is a solid at 25° C. is determined from the relative dielectric constant of the 50% by mass aqueous solution is as follows. The water-soluble organic solvent that may serve as a constituent component of the aqueous ink out of the water-soluble organic solvents that are a solid at 25° C. may be difficult to prepare an aqueous solution having a high concentration of more than 50% by mass. Meanwhile, in an aqueous solution having a low concentration of 10% by mass or less, the relative dielectric constant of water becomes dominant, and a probable (effective) relative dielectric constant value of the water-soluble organic solvent cannot be obtained. In view of the foregoing, as a result of the verifications made by the inventors of the present invention, it was found that an aqueous solution serving as a measurement object was able to be prepared by most of the water-soluble organic solvents that were a solid at 25° C. that may be used for an ink, and a required relative dielectric constant was also consistent with the effect of the present invention. From such reason, the 50% by mass aqueous solution was adopted to be utilized. For a water-soluble organic solvent that is a solid at 25° C. in which a 50% by mass aqueous solution cannot be prepared because of a low degree of solubility in water, a relative dielectric constant value calculated in conformity with the case in which the above-mentioned εₛₒₗ is determined is used for convenience by utilizing an aqueous solution having a saturated concentration.

Examples of the other water-soluble organic solvent except the first water-soluble organic solvent having a relative dielectric constant of 20.0 or more to 30.0 or less may include urea (110.3), ethylene urea (49.7), glycerin (42.3), ethylene glycol (40.4), 1-(2-hydroxyethyl)-2-pyrrolidone (37.6), trimethylolpropane (33.7), methanol (33.1), N-methyl-2-pyrrolidone (32.0), triethanolamine (31.9), diethylene glycol (31.7), 1,4-butanediol (31.1), dipropylene glycol (19.7), polyethylene glycol having a number-average molecular weight of 200 (18.9), 2-ethyl-1,3-hexanediol (18.5), isopropanol (18.3), 1,3-bis(2-hydroxyethyl)-5,5-dimethylhydantoin (16.0), 1,2-hexanediol (14.8), propylene glycol monomethyl ether (12.4), n-propanol (12.0), polyethylene glycol having a number-average molecular weight of 600 (11.4), diethylene glycol monobutyl ether (11.0), triethylene glycol monobutyl ether (9.8), ethylene glycol monobutyl ether (9.4), tetraethylene glycol monobutyl ether (9.4), tripropylene glycol monomethyl ether (8.5), 1,6-hexanediol (7.1) and polyethylene glycol having a number-average molecular weight of 1,000 (4.6) (a numerical value in parentheses represents a relative dielectric constant at 25° C.). The other water-soluble organic solvent is preferably a water-soluble organic solvent having a lower vapor pressure than that of water, a water-soluble organic solvent having a relative dielectric constant of 2.0 or more, or a water-soluble organic solvent having a relative dielectric constant of 150.0 or less.

### [Surfactant]

The ink preferably further contains a surfactant. Examples of the surfactant may include an anionic surfactant, a cationic surfactant, a nonionic surfactant, an amphoteric surfactant and other surfactants. Of those, a nonionic surfactant is preferably used.

Examples of the anionic surfactant may include a polyoxyethylene alkylether sulfuric acid ester salt, a polyoxyethylene alkylether sulfonic acid salt, a polyoxyethylene alkyl phenyl ether sulfuric acid ester salt, a polyoxyethylene alkyl phenyl ether sulfonic acid salt, an alpha-sulfo fatty acid ester salt, an alkylbenzene sulfonic acid salt, an alkylphenol sulfonic acid salt, an alkylnaphthalene sulfonic acid salt, an alkyltetralin sulfonic acid salt and a dialkyl sulfosuccinic acid salt. Examples of the cationic surfactant may include an alkyltrimethylammonium salt and a dialkyldimethylammonium chloride.

Examples of the nonionic surfactant may include an acetylene glycol-based surfactant, a polyoxyethylene alkylether, a polyoxyethylene fatty acid ester, a polyoxyethylene alkyl phenyl ether, a fatty acid diethanol amide and a polyoxyethylene-polyoxypropylene block copolymer. An example of the amphoteric surfactant is an alkyl carboxybetaine. Examples of the other surfactant may include a fluorine-based surfactant and a silicone-based surfactant.

The magenta ink preferably contains an acetylene glycol-based surfactant. The acetylene glycol-based surfactant is suitable because the balance between the additive amount to the ink and the ability to reduce the surface tension is good, and the additive amount at the time of appropriately setting the surface tension of the ink becomes an amount that moderately weakens the binding force of the quinacridone pigment. In a case of a surfactant having an excessively high ability to reduce the surface tension, it may become difficult to add an amount that moderately reduces the binding force of the quinacridone pigment to the ink. Meanwhile, in a case of a surfactant having an excessively low ability to reduce the surface tension, the binding force of the quinacridone pigment can be reduced, but the additive amount is increased, and hence the effect of improving the intermittent ejection stability may be reduced.

The content (% by mass) of the surfactant in the ink is preferably 0.10% by mass or more to 5.00% by mass or less, more preferably 0.10% by mass or more to 2.00% by mass or less with respect to the total mass of the ink.

### [Other Components]

Besides the above-mentioned components, as required, the ink may also contain various additives, such as an antifoam agent, a pH adjuster, a viscosity adjuster, a rust preventive, a preservative, a fungicide, an antioxidant and a reduction inhibitor. These additives are not included in the object for measuring the relative dielectric constant.

### [Physical Properties of Ink]

The ink is an aqueous ink to be applied to an ink jet system. Accordingly, from the viewpoint of reliability, it is preferred that the physical property values of the ink be appropriately controlled. Specifically, the static surface tension of the ink at 25° C. is preferably 28 mN/m or more to 45 mN/m or less. In addition, the viscosity of the ink at 25° C. is preferably 1.0 mPa·s or more to 5.0 mPa·s or less, more preferably 1.0 mPa·s or more to 3.0 mPa·s or less. The pH of the ink at 25° C. is preferably 5.0 or more to 9.5 or less.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

### <Preparation of Pigment Dispersion Liquid>

### (Pigment Dispersion Liquid 1)

A styrene-acrylic acid copolymer having an acid value of 120 mgKOH/g and a weight-average molecular weight of 10,000 was neutralized with a 10% potassium hydroxide aqueous solution. 10.0 Parts of C.I. Pigment Red 122 (quinacridone pigment), 3.0 parts of the neutralized styrene-acrylic acid copolymer (solid content) and 85.0 parts of ion-exchanged water were mixed to provide a mixture. The resultant mixture was dispersed through use of a sand grinder for 1 hour and then a coarse particle was removed by centrifugation treatment. Further, the supernatant was filtered with a microfilter having a pore size of 3.0 μm (manufactured by FUJIFILM Corporation) under pressure to provide a pigment dispersion liquid 1 in a state in which C.I. Pigment Red 122 was dispersed in the water by the resin. The content of the pigment in the pigment dispersion liquid 1 was 15.00% and the content of the resin dispersant therein was 4.50%.

### (Pigment Dispersion Liquid 2)

A pigment dispersion liquid 2 was obtained similarly to the pigment dispersion liquid 1 described above except that C.I. Pigment Violet 19 (quinacridone pigment) was used instead of C.I. Pigment Red 122. The content of the pigment in the pigment dispersion liquid 2 was 15.00% and the content of the resin dispersant therein was 4.50%.

### (Pigment Dispersion Liquid 3)

A pigment dispersion liquid 3 was obtained similarly to the pigment dispersion liquid 1 described above except that a solid solution of C.I. Pigment Red 122 and C.I. Pigment Violet 19 (solid solution pigment of quinacridone) was used instead of C.I. Pigment Red 122. The content of the pigment in the pigment dispersion liquid 3 was 15.00% and the content of the resin dispersant therein was 4.50%.

### (Pigment Dispersion Liquid 4)

A pigment dispersion liquid 4 was obtained similarly to the pigment dispersion liquid 1 described above except that C.I. Pigment Red 150 (azo pigment) was used instead of C.I. Pigment Red 122. The content of the pigment in the pigment dispersion liquid 4 was 15.00% and the content of the resin dispersant therein was 4.50%.

### (Pigment Dispersion Liquid 5)

A pigment dispersion liquid 5 was obtained similarly to the pigment dispersion liquid 1 described above except that C.I. Pigment Blue 15:3 (phthalocyanine pigment) was used instead of C.I. Pigment Red 122. The content of the pigment in the pigment dispersion liquid 5 was 15.00% and the content of the resin dispersant therein was 4.50%.

### (Pigment Dispersion Liquid 6)

A pigment dispersion liquid 6 was obtained similarly to the pigment dispersion liquid 1 described above except that C.I. Pigment Blue 15:4 (phthalocyanine pigment) was used instead of C.I. Pigment Red 122. The content of the pigment in the pigment dispersion liquid 6 was 15.00% and the content of the resin dispersant therein was 4.50%.

### (Pigment Dispersion Liquid 7)

A pigment dispersion liquid 7 was obtained similarly to the pigment dispersion liquid 1 described above except that C.I. Pigment Yellow 74 (azo pigment) was used instead of C.I. Pigment Red 122. The content of the pigment in the pigment dispersion liquid 7 was 15.00% and the content of the resin dispersant therein was 4.50%.

### (Pigment Dispersion Liquid 8)

A pigment dispersion liquid 8 was obtained similarly to the pigment dispersion liquid 1 described above except that C.I. Pigment Yellow 155 (azo pigment) was used instead of C.I. Pigment Red 122. The content of the pigment in the pigment dispersion liquid 8 was 15.00% and the content of the resin dispersant therein was 4.50%.

### <Preparation of Liquid Containing Dye>

Each of dyes 1 to 3 described below was dissolved in ion-exchanged water to provide a liquid containing each of the dyes 1 to 3 (having a dye content of 19.50%).
Dye 1: C.I. Acid Red 289
Dye 2: C.I. Direct Blue 199
Dye 3: C.I. Direct Yellow 132

### <Preparation of Ink>

Components (unit: %) shown in the upper section of Table 1 (Table 1-1 to Table 1-4) were mixed and sufficiently stirred. After that, the mixtures were filtered with a polypropylene filter having a pore size of 2.5 μm (manufactured by Pall Corporation) under pressure to prepare respective inks. In Table 1, the numerical value added to polyethylene glycol is the number-average molecular weight. Further, the product name “ACETYLENOL E100” and the product name “ACETYLENOL E60” are both acetylene glycol-based nonionic surfactants (manufactured by Kawaken Fine Chemicals Co., Ltd.). Further, the product name “Pluronic L31” is a surfactant having a polyoxyethylene-polyoxypropylene block copolymer structure (manufactured by ADEKA Corporation), and the product name “Zonyl FS3100” is a fluorine-based surfactant (manufactured by The Chemours Company). In Table 1, the number in the parentheses added to the water-soluble organic solvent indicates the relative dielectric constant.

TABLE 1-1
Composition and characteristics of ink

| | Ink | | | | | | | |
|---|---|---|---|---|---|---|---|---|
| | M1 | M2 | M3 | M4 | M5 | M6 | M7 | M8 |
| Pigment dispersion liquid 1 | 23.33 | | | 33.33 | 16.67 | 20.00 | 26.67 | 27.27 |
| Pigment dispersion liquid 2 | | 23.33 | | | | | | |
| Pigment dispersion liquid 3 | | | 23.33 | | | | | |
| Pigment dispersion liquid 4 | 10.00 | 10.00 | 10.00 | | 16.67 | 13.33 | 6.67 | 6.06 |
| Pigment dispersion liquid 5 | | | | | | | | |
| Pigment dispersion liquid 6 | | | | | | | | |
| Pigment dispersion liquid 7 | | | | | | | | |
| Pigment dispersion liquid 8 | | | | | | | | |
| Liquid containing dye 1 | | | | | | | | |
| Liquid containing dye 2 | | | | | | | | |
| Liquid containing dye 3 | | | | | | | | |
| Glycerin (42.3) | 10.00 | 10.00 | 10.00 | 10.00 | 10.00 | 10.00 | 10.00 | 10.00 |
| Diethylene glycol (31.7) | | | | | | | | |
| 1,3-Butanediol (30.0) | | | | | | | | |
| Propylene glycol (28.8) | | | | | | | | |
| 2-Pyrrolidone (28.0) | | | | | | | | |
| Triethylene glycol (22.7) | 13.00 | 13.00 | 13.00 | 13.00 | 13.00 | 13.00 | 13.00 | 13.00 |
| Tetraethylene glycol (20.8) | | | | | | | | |
| 2-Ethyl-1,3-hexanediol (18.5) | | | | | | | | |
| 1,2-Hexanediol (14.8) | 1.00 | 1.00 | 1.00 | 1.00 | 1.00 | 1.00 | 1.00 | 1.00 |
| Polyethylene Glycol 1000 (4.6) | 1.00 | 1.00 | 1.00 | 1.00 | 1.00 | 1.00 | 1.00 | 1.00 |
| ACETYLENOL E100 | 0.50 | 0.50 | 0.50 | 0.50 | 0.50 | 0.50 | 0.50 | 0.50 |
| ACETYLENOL E60 | | | | | | | | |
| Pluronic L31 | | | | | | | | |
| Zonyl FS3100 | | | | | | | | |
| Pure water | 41.17 | 41.17 | 41.17 | 41.17 | 41.16 | 41.17 | 41.16 | 41.17 |
| Content Q (%) of quinacridone | 3.50 | 3.50 | 3.50 | 5.00 | 2.50 | 3.00 | 4.00 | 4.09 |
| pigment | | | | | | | | |
| Content N (%) of non- | 1.50 | 1.50 | 1.50 | 0.00 | 2.50 | 2.00 | 1.00 | 0.91 |
| quinacridone pigment | | | | | | | | |
| Value (times) of Q/N | 2.3 | 2.3 | 2.3 | — | 1.0 | 1.5 | 4.0 | 4.5 |
| Content (%) of resin | 1.50 | 1.50 | 1.50 | 1.50 | 1.50 | 1.50 | 1.50 | 1.50 |
| Content (%) of first water- | 13.00 | 13.00 | 13.00 | 13.00 | 13.00 | 13.00 | 13.00 | 13.00 |
| soluble organic solvent | | | | | | | | |
| Content (%) of water | 68.00 | 68.00 | 68.00 | 68.00 | 68.00 | 68.00 | 68.00 | 68.00 |

TABLE 1-2
Composition and characteristics of ink

| | Ink | | | | | | |
|---|---|---|---|---|---|---|---|
| | M9 | M10 | M11 | M12 | M13 | M14 | M15 |
| Pigment dispersion liquid 1 | 23.33 | 23.33 | 23.33 | 23.33 | 23.33 | 23.33 | 23.33 |
| Pigment dispersion liquid 2 | | | | | | | |
| Pigment dispersion liquid 3 | | | | | | | |
| Pigment dispersion liquid 4 | 10.00 | 10.00 | 10.00 | 10.00 | 10.00 | 10.00 | 10.00 |
| Pigment dispersion liquid 5 | | | | | | | |
| Pigment dispersion liquid 6 | | | | | | | |
| Pigment dispersion liquid 7 | | | | | | | |
| Pigment dispersion liquid 8 | | | | | | | |
| Liquid containing dye 1 | | | | | | | |
| Liquid containing dye 2 | | | | | | | |
| Liquid containing dye 3 | | | | | | | |
| Glycerin (42.3) | 10.00 | 10.00 | 10.00 | 10.00 | 10.00 | 10.00 | 16.00 |
| Diethylene glycol (31.7) | | | | | | 13.00 | |
| 1,3-Butanediol (30.0) | | | | | 13.00 | | |
| Propylene glycol (28.8) | | | | 13.00 | | | |
| 2-Pyrrolidone (28.0) | | | 13.00 | | | | |
| Triethylene glycol (22.7) | | | | | | | 7.00 |
| Tetraethylene glycol (20.8) | | 13.00 | | | | | |
| 2-Ethyl-1,3-hexanediol (18.5) | 13.00 | | | | | | |
| 1,2-Hexanediol (14.8) | 1.00 | 1.00 | 1.00 | 1.00 | 1.00 | 1.00 | 1.00 |
| Polyethylene Glycol 1000 | 1.00 | 1.00 | 1.00 | 1.00 | 1.00 | 1.00 | 1.00 |
| (4.6) | | | | | | | |
| ACETYLENOL E100 | 0.50 | 0.50 | 0.50 | 0.50 | 0.50 | 0.50 | 0.50 |
| ACETYLENOL E60 | | | | | | | |
| Pluronic L31 | | | | | | | |
| Zonyl FS3100 | | | | | | | |
| Pure water | 41.17 | 41.17 | 41.17 | 41.17 | 41.17 | 41.17 | 41.17 |
| Content Q (%) of quinacridone | 3.50 | 3.50 | 3.50 | 3.50 | 3.50 | 3.50 | 3.50 |
| pigment | | | | | | | |
| Content N (%) of non- | 1.50 | 1.50 | 1.50 | 1.50 | 1.50 | 1.50 | 1.50 |
| quinacridone pigment | | | | | | | |
| Value (times) of Q/N | 2.3 | 2.3 | 2.3 | 2.3 | 2.3 | 2.3 | 2.3 |
| Content (%) of resin | 1.50 | 1.50 | 1.50 | 1.50 | 1.50 | 1.50 | 1.50 |
| Content (%) of first water- | 0.00 | 13.00 | 13.00 | 13.00 | 13.00 | 0.00 | 7.00 |
| soluble organic solvent | | | | | | | |
| Content (%) of water | 68.00 | 68.00 | 68.00 | 68.00 | 68.00 | 68.00 | 68.00 |

TABLE 1-3
Composition and characteristics of ink

| | Ink | | | | | | | |
|---|---|---|---|---|---|---|---|---|
| | M16 | M17 | M18 | M19 | M20 | M21 | M22 | M23 |
| Pigment dispersion liquid 1 | 23.33 | 23.33 | 23.33 | 23.33 | 23.33 | 23.33 | 33.33 | |
| Pigment dispersion liquid 2 | | | | | | | | |
| Pigment dispersion liquid 3 | | | | | | | | |
| Pigment dispersion liquid 4 | 10.00 | 10.00 | 10.00 | 10.00 | 10.00 | 10.00 | | 33.33 |
| Pigment dispersion liquid 5 | | | | | | | | |
| Pigment dispersion liquid 6 | | | | | | | | |
| Pigment dispersion liquid 7 | | | | | | | | |
| Pigment dispersion liquid 8 | | | | | | | | |
| Liquid containing dye 1 | | | | | | | | |
| Liquid containing dye 2 | | | | | | | | |
| Liquid containing dye 3 | | | | | | | | |
| Glycerin (42.3) | 10.00 | 13.00 | 10.00 | 10.00 | 10.00 | 5.00 | 8.00 | 10.00 |
| Diethylene glycol (31.7) | | | | | | | | |
| 1,3-Butanediol (30.0) | | | | | | | | |
| Propylene glycol (28.8) | | | | | | | | |
| 2-Pyrrolidone (28.0) | | | | | | | | |
| Triethylene glycol (22.7) | 7.00 | 10.00 | 13.00 | 13.00 | 13.00 | 10.00 | 7.00 | 13.00 |
| Tetraethylene glycol (20.8) | | | | | | | | |
| 2-Ethyl-1,3-hexanediol (18.5) | | | | | | | | |
| 1,2-Hexanediol (14.8) | 1.00 | 1.00 | 1.00 | 1.00 | 1.00 | 1.00 | 1.00 | 1.00 |
| Polyethylene Glycol 1000 (4.6) | 7.00 | 1.00 | 1.00 | 1.00 | 1.00 | 1.00 | 1.00 | 1.00 |
| ACETYLENOL E100 | 0.50 | 0.50 | | | | 0.50 | | 0.50 |
| ACETYLENOL E60 | | | 0.20 | | | | | |
| Pluronic L31 | | | | 2.00 | | | 2.00 | |
| Zonyl FS3100 | | | | | 0.08 | | | |
| Pure water | 41.17 | 41.17 | 41.47 | 39.67 | 41.59 | 49.17 | 47.67 | 41.17 |
| Content Q (%) of quinacridone | 3.50 | 3.50 | 3.50 | 3.50 | 3.50 | 3.50 | 5.00 | 0.00 |
| pigment | | | | | | | | |
| Content N (%) of non- | 1.50 | 1.50 | 1.50 | 1.50 | 1.50 | 1.50 | 0.00 | 5.00 |
| quinacridone pigment | | | | | | | | |
| Value (times) of Q/N | 2.3 | 2.3 | 2.3 | 2.3 | 2.3 | 2.3 | — | 0.0 |
| Content (%) of resin | 1.50 | 1.50 | 1.50 | 1.50 | 1.50 | 1.50 | 1.50 | 1.50 |
| Content (%) of first water- | 7.00 | 10.00 | 13.00 | 13.00 | 13.00 | 10.00 | 7.00 | 13.00 |
| soluble organic solvent | | | | | | | | |
| Content (%) of water | 68.00 | 68.00 | 68.30 | 66.50 | 68.42 | 76.00 | 74.50 | 68.00 |

TABLE 1-4
Composition and characteristics of ink

| | Ink | | | | | | |
|---|---|---|---|---|---|---|---|
| | M24 | C1 | C2 | C3 | Y1 | Y2 | Y3 |
| Pigment dispersion liquid 1 | | | | | | | |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | 26.67 | | | | | |
| Pigment dispersion liquid 6 | | | 26.67 | | | | |
| Pigment dispersion liquid 7 | | | | | 26.67 | | |
| Pigment dispersion liquid 8 | | | | | | 26.67 | |
| Liquid containing dye 1 | 33.33 | | | | | | |
| Liquid containing dye 2 | | | | 33.33 | | | |
| Liquid containing dye 3 | | | | | | | 33.33 |
| Glycerin (42.3) | 10.00 | 11.00 | 11.00 | 10.00 | 11.00 | 11.00 | 10.00 |
| Diethylene glycol (31.7) | | | | | | | |
| 1,3-Butanediol (30.0) | | | | | | | |
| Propylene glycol (28.8) | | | | | | | |
| 2-Pyrrolidone (28.0) | | | | | | | |
| Triethylene glycol (22.7) | 13.00 | 9.00 | 9.00 | 13.00 | 9.00 | 9.00 | 13.00 |
| Tetraethylene glycol (20.8) | | | | | | | |
| 2-Ethyl-1,3-hexanediol (18.5) | | | | | | | |
| 1,2-Hexanediol (14.8) | 1.00 | 1.00 | 1.00 | 1.00 | 1.00 | 1.00 | 1.00 |
| Polyethylene Glycol 1000 (4.6) | 1.00 | 1.00 | 1.00 | 1.00 | 1.00 | 1.00 | 1.00 |
| ACETYLENOL E100 | 0.50 | 0.50 | 0.50 | 0.50 | 0.50 | 0.50 | 0.50 |
| ACETYLENOL E60 | | | | | | | |
| Pluronic L31 | | | | | | | |
| Zonyl FS3100 | | | | | | | |
| Pure water | 41.17 | 50.83 | 50.83 | 41.17 | 50.83 | 50.83 | 41.17 |
| Content Q (%) of quinacridone | 0.00 | 0.00 | 0.00 | 0.00 | 0.00 | 0.00 | 0.00 |
| pigment | | | | | | | |
| Content N (%) of non- | 0.00 | 4.00 | 4.00 | 0.00 | 4.00 | 0.00 | 0.00 |
| quinacridone pigment | | | | | | | |
| Value (times) of Q/N | — | 0.0 | 0.0 | — | 0.0 | — | — |
| Content (%) of resin | 0.00 | 1.20 | 1.20 | 0.00 | 1.20 | 0.00 | 0.00 |
| Content (%) of first water- | 13.00 | 9.00 | 9.00 | 13.00 | 9.00 | 9.00 | 13.00 |
| soluble organic solvent | | | | | | | |
| Content (%) of water | 68.00 | 72.30 | 72.30 | 68.00 | 72.30 | 72.30 | 68.00 |

### <Configuration of Recording Unit>

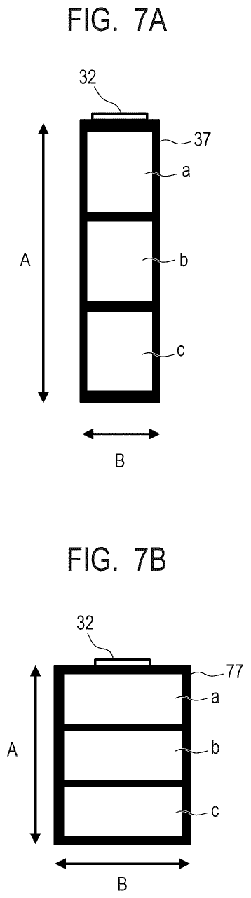

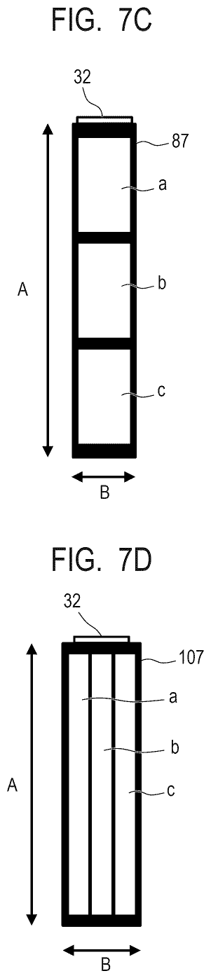

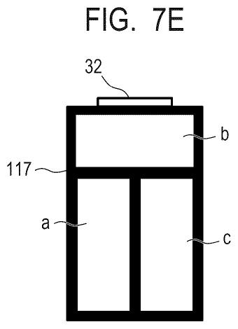

A recording head employing a system of ejecting an ink by applying thermal energy was prepared. In the recording element substrate forming the recording head, an ejection orifice array formed of 384 ejection orifices arrayed at an array density of 600 dpi is arranged. The mass of an ink droplet ejected from one ejection orifice is 5.5 ng. Further, thermoplastic resin compositions were respectively molded to provide recording units 1 to 9 having ink storage portions arranged in the manner illustrated in FIG. 7A to FIG. 7E. As the thermoplastic resin composition, there was used a thermoplastic resin composition obtained by adding, as the filler material, 25 parts of E-glass chopped strand having a length of 5 mm to 100 parts of a thermoplastic resin being a mixture of a styrene-based resin and polyphenylene ether. The characteristics of the obtained recording units are shown in Table 2.

In the ink storage portion 37 illustrated in FIG. 7A, three storage parts “a” to “c” are arrayed in a direction orthogonal to a scanning direction of the recording head. In an ink storage portion 77 illustrated in FIG. 7B, three storage parts “a” to “c” are arrayed in a direction orthogonal to a scanning direction of the recording head. In an ink storage portion 87 illustrated in FIG. 7C, three storage parts “a” to “c” are arrayed in a direction orthogonal to a scanning direction of the recording head. In an ink storage portion 107 illustrated in FIG. 7D, three storage parts “a” to “c” are arrayed in a direction parallel to the scanning direction of the recording head. In an ink storage portion 117 illustrated in FIG. 7E, three storage parts “a” to “c” are arranged in a T-shape instead of being arranged in one direction. Ink storage portions 7 and 8 shown in Table 2 were obtained by molding a thermoplastic resin that is a mixture of a styrene-based resin and polyphenylene ether, that is, a thermoplastic resin having no filler material added thereto. In addition, the recording head is bonded to the obtained ink storage portion without intermediation of any other member to manufacture the recording unit.

TABLE 2
Characteristics of recording units

| Recording unit | Filler material | Shape | Ratio A/B |
|---|---|---|---|
| 1 | Present | FIG. 7A | 3.0 |
| 2 | Present | FIG. 7B | 1.5 |
| 3 | Present | FIG. 7B | 2.0 |
| 4 | Present | FIG. 7C | 4.0 |
| 5 | Present | FIG. 7C | 4.5 |
| 6 | Present | FIG. 7D | 3.0 |
| 7 | Absent | FIG. 7A | 3.0 |
| 8 | Absent | FIG. 7E | — |
| 9 | Present | FIG. 7E | — |

### <Evaluation>

### (Ink Jet Recording Apparatus)

A product name “PIXUS TS5130S” (manufactured by Canon Inc.) was prepared as an apparatus 1 as an ink jet recording apparatus of a type in which, when an ink stored inside of the ink storage portion (ink cartridge) has been consumed, the ink storage portion is replaced with a new ink storage portion filled with the ink. Further, a product name “G3370” (manufactured by Canon Inc.) was prepared as an apparatus 2 as an ink jet recording apparatus of a type in which an ink storage portion (sub tank) on a carriage and an ink storage portion (main tank) placed in the apparatus are connected to each other by a tube through which the ink flows. Those apparatus were modified to allow the prepared recording unit described above to be mounted thereon. In this Example, the recording duty of a solid image recorded under the following condition is defined as 100%: two ink droplets having a mass per droplet of 5.5 ng are applied to a unit region measuring 1/600 inch by 1/600 inch. In the present invention, in evaluation criteria for each of the following items, while levels “AAA,” “AA,” “A” and “B” were defined as acceptable levels, a level “C” was defined as an unacceptable level. The evaluation results are shown in Table 3 (Table 3-1 to Table 3-4). In Table 3, symbols (“a” to “c”) indicating the positions of the inks of the respective colors correspond to symbols (“a” to “c”) in FIG. 7A to FIG. 7E.

### (Strength of Ink Storage Portion)

In order to promote deformation by the heat of the ink storage portion (casing), the recording unit was stored for 1 month under an environment at a temperature of 60° C. Under a state in which the upper surface of the ink storage portion was directed downward in the gravity direction and the ejection orifice surface of the recording head was directed upward, the recording unit was dropped twice on a lauan material from a height of 80 cm. The ink storage portion of the recording unit after dropping was visually observed, and the strength of the ink storage portion was evaluated in accordance with the evaluation criteria shown below.
A: No cracking or chipping of the ink storage portion occurred.
B: Cracking or chipping of the ink storage portion occurred, but no ink leakage was observed.
C: Cracking or chipping of the ink storage portion occurred, and ink leakage was observed.

### (Intermittent Ejection Stability)

The mass of each magenta ink was concentrated through evaporation by 15%, 17% and 20% to prepare concentrated inks (15% concentrated ink, 17% concentrated ink and 20% concentrated ink). The prepared concentrated ink was injected into the ink storage portion of the recording unit and the ink storage portion was mounted to the ink jet recording apparatus. After that, the ink storage portion was left for 1 month under an environment at a temperature of 30° C. and a relative humidity of 10%. After the leaving, the ink was ejected drop by drop to the recording medium from each of the ejection orifices forming the ejection orifice array of the magenta ink, and a pattern of recording, at intervals of 2 seconds, fifteen ruled lines each having a width corresponding to one dot of an ink droplet and a length corresponding to an array width of the ejection orifice array was recorded continuously for 7 minutes. A glossy paper of a product name “Photo Paper Plus Glossy & Gold” (manufactured by Canon Inc.) was used as the recording medium, and the recording environment was set to a temperature of 15° C. and a relative humidity of 10%. After 7 minutes from the start of the recording, the adhesion position of the ink was observed for the first ruled line among the recorded fifteen ruled lines, and the intermittent ejection stability of the ink was evaluated in accordance with the evaluation criteria shown below.
AAA: No distortion was observed in the first ruled line recorded with the 20% concentrated ink.
AA: A distortion of the adhesion position was observed in the first ruled line recorded with the 20% concentrated ink, but no distortion was observed in the first ruled line recorded with the 17% concentrated ink.
A: A distortion of the adhesion position was observed in the first ruled line recorded with the 20% concentrated ink, but no distortion was observed in the first ruled line recorded with the 15% concentrated ink.
B: A distortion of the adhesion position was observed in the first ruled line recorded with the 15% concentrated ink, but no discontinuous portion was observed in the ruled line.
C: A distortion of the adhesion position was observed in the first ruled line recorded with the 15% concentrated ink, and a discontinuous portion was observed in the ruled line.

### (Light Fastness of Image)

Through use of the ink jet recording apparatus described above, a solid image of 2 cm×2 cm having a recording duty of 100% was recorded with the magenta ink on a recording medium (PPC sheet, product name “CS-680,” manufactured by Canon Inc.). The recording environment was set to a temperature of 25° C. and a relative humidity of 50%. Through use of a spectrophotometer (product name “Spectorolino,” manufactured by Gretag Macbeth GmbH), the optical density of the recorded solid image (referred to as “optical density of image before test”) was measured under conditions of a light source of D50 and a visual field of 2°. After that, the recorded matter was put in a xenon test apparatus (product name “Atlas Ci4400 Weather-Ometer,” manufactured by Toyo Seiki Seisaku-sho, Ltd.), and the solid image was irradiated with xenon light for 72 hours under conditions of a temperature of 23° C., a relative humidity of 50% and a xenon light irradiation amount of 550 W/m². Next, the optical density of the solid image was measured again (referred to as “optical density of image after test”). The residual rate of the optical density was calculated by the following equation (A). Then, the light fastness of the image was evaluated in accordance with the evaluation criteria shown below.

$$Residual rate of optical density ( \% ) = ( “ optical density of image after test ” / “ optical density of image before test ” ) \times 100 \qquad ( A )$$

A: The residual rate of the optical density was 90% or more.
B: The residual rate of the optical density was 80% or more to less than 90%.
C: The residual rate of the optical density was less than 80%.

### (Apparatus Size)

The apparatus 1 or 2 was modified so as to allow the recording unit to be mounted thereon. Then, the sizes of the apparatus before and after the modification were compared to evaluate the apparatus size in accordance with the evaluation criteria shown below.
A: Downsizing was achieved through modification.
B: An equivalent size was obtained through modification.
C: The size was increased through modification.

TABLE 3-1
Evaluation conditions unit

| | | | Recording unit | | | |
|---|---|---|---|---|---|---|
| | | | | Position of | Position | Position |
| | | Kind of | | magenta | of cyan | of yellow |
| | | apparatus | Kind | ink | ink | ink |
| Example | 1 | 1 | 1 | b | a | c |
| | 2 | 1 | 1 | b | a | c |
| | 3 | 1 | 1 | b | a | c |
| | 4 | 1 | 1 | b | a | c |
| | 5 | 1 | 1 | b | a | c |
| | 6 | 1 | 1 | b | a | c |
| | 7 | 1 | 1 | b | a | c |
| | 8 | 1 | 1 | b | a | c |
| | 9 | 1 | 1 | b | a | c |
| | 10 | 1 | 1 | b | a | c |
| | 11 | 1 | 1 | b | a | c |
| | 12 | 1 | 1 | b | a | c |
| | 13 | 1 | 1 | b | a | c |
| | 14 | 1 | 1 | b | a | c |
| | 15 | 1 | 1 | b | a | c |
| | 16 | 1 | 1 | b | a | c |
| | 17 | 1 | 1 | b | a | c |
| | 18 | 1 | 1 | b | a | c |
| | 19 | 1 | 1 | b | a | c |
| | 20 | 1 | 1 | b | a | c |
| | 21 | 1 | 1 | b | a | c |
| | 22 | 1 | 1 | b | a | c |
| | 23 | 1 | 1 | b | a | c |
| | 24 | 1 | 1 | b | a | c |
| | 25 | 1 | 2 | b | a | c |
| | 26 | 1 | 3 | b | a | c |
| | 27 | 1 | 4 | b | a | c |
| | 28 | 1 | 5 | b | a | c |
| | 29 | 1 | 6 | b | a | c |
| | 30 | 2 | 1 | b | a | c |
| | 31 | 1 | 1 | b | a | c |

TABLE 3-2
Evaluation conditions and evaluation results

| | | | | | Evaluation results | | | |
|---|---|---|---|---|---|---|---|---|
| | | Kind of ink | | | | Intermittent | | |
| | | Magenta | Cyan | Yellow | | ejection | Light | Apparatus |
| | | Ink | Ink | Ink | Strength | stability | fastness | size |
| Example | 1 | M1 | C1 | Y1 | A | AAA | AA | A |
| | 2 | M2 | C1 | Y1 | A | AAA | AA | A |
| | 3 | M3 | C1 | Y1 | A | AAA | AA | A |
| | 4 | M1 | C2 | Y1 | A | AAA | AA | A |
| | 5 | M1 | C1 | Y2 | A | AAA | AA | A |
| | 6 | M1 | C2 | Y2 | A | AAA | AA | A |
| | 7 | M4 | C1 | Y1 | A | A | AA | A |
| | 8 | M5 | C1 | Y1 | A | AAA | A | A |
| | 9 | M6 | C1 | Y1 | A | AAA | AA | A |
| | 10 | M7 | C1 | Y1 | A | AAA | AA | A |
| | 11 | M8 | C1 | Y1 | A | AA | AA | A |
| | 12 | M9 | C1 | Y1 | A | AA | AA | A |
| | 13 | M10 | C1 | Y1 | A | AAA | AA | A |
| | 14 | M11 | C1 | Y1 | A | AAA | AA | A |
| | 15 | M12 | C1 | Y1 | A | AAA | AA | A |
| | 16 | M13 | C1 | Y1 | A | AAA | AA | A |
| | 17 | M14 | C1 | Y1 | A | AA | AA | A |
| | 18 | M15 | C1 | Y1 | A | AA | AA | A |
| | 19 | M16 | C1 | Y1 | A | A | AA | A |
| | 20 | M17 | C1 | Y1 | A | AAA | AA | A |
| | 21 | M18 | C1 | Y1 | A | AAA | AA | A |
| | 22 | M19 | C1 | Y1 | A | AA | AA | A |
| | 23 | M20 | C1 | Y1 | A | AA | AA | A |
| | 24 | M21 | C1 | Y1 | A | AA | AA | A |
| | 25 | M1 | C1 | Y1 | A | AAA | AA | B |
| | 26 | M1 | C1 | Y1 | A | AAA | AA | A |
| | 27 | M1 | C1 | Y1 | A | AAA | AA | A |
| | 28 | M1 | C1 | Y1 | B | AAA | AA | A |
| | 29 | M1 | C1 | Y1 | B | AAA | AA | A |
| | 30 | M1 | C1 | Y1 | A | AAA | AA | A |
| | 31 | M22 | C1 | Y1 | A | B | AA | A |

TABLE 3-3
Evaluation conditions

| | | | Recording unit | | | |
|---|---|---|---|---|---|---|
| | | | | Position | Position | Position |
| | | Kind of | | of cyan | of magenta | of yellow |
| | | apparatus | Kind | ink | ink | ink |
| Comparative | 1 | 1 | 7 | b | a | c |
| Example | 2 | 1 | 7 | b | a | c |
| | 3 | 1 | 8 | b | a | c |
| | 4 | 1 | 9 | b | a | c |
| | 5 | 1 | 9 | b | a | c |
| | 6 | 1 | 1 | b | a | c |
| | 7 | 1 | 1 | a | b | c |
| | 8 | 1 | 6 | a | b | c |
| Reference | 1 | 1 | 9 | b | a | c |
| Example | 2 | 1 | 1 | a | b | c |
| | 3 | 1 | 1 | b | c | a |
| | 4 | 1 | 1 | c | a | b |

TABLE 3-4
Evaluation conditions and evaluation results

| | | | | | Evaluation results | | | |
|---|---|---|---|---|---|---|---|---|
| | | Kind of ink | | | | Intermittent | | |
| | | Magenta | Cyan | Yellow | | ejection | Light | Apparatus |
| | | Ink | Ink | Ink | Strength | stability | fastness | size |
| Comparative | 1 | M1 | C1 | Y1 | C | AAA | AA | A |
| Example | 2 | M23 | C1 | Y1 | C | AAA | C | A |
| | 3 | M1 | C1 | Y1 | C | AAA | AA | A |
| | 4 | M1 | C1 | Y1 | A | C | AA | A |
| | 5 | M23 | C1 | Y1 | A | AA | C | A |
| | 6 | M23 | C1 | Y1 | A | AAA | C | A |
| | 7 | M1 | C1 | Y1 | A | C | AA | A |
| | 8 | M1 | C1 | Y1 | A | C | AA | A |
| Reference | 1 | M24 | C3 | Y3 | A | AAA | C | A |
| Example | 2 | M24 | C3 | Y3 | A | AAA | C | A |
| | 3 | M24 | C3 | Y3 | A | AAA | C | A |
| | 4 | M24 | C3 | Y3 | A | AAA | C | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-128300, filed Aug. 7, 2023, and Japanese Patent Application No. 2024-117455, filed Jul. 23, 2024, which are hereby incorporated by reference herein in their entirety.

What is claimed is:

1. An ink jet recording method using an ink jet recording apparatus, the ink jet recording apparatus comprising:
an aqueous ink comprising a pigment;
an ink storage portion which is configured to store the aqueous ink, and is formed from a thermoplastic resin composition comprising a filler material; and
a recording head to be bonded to the ink storage portion, the recording head having formed therein an ejection orifice configured to eject the aqueous ink supplied from the ink storage portion,
the ink jet recording method comprising recording an image by applying the aqueous ink ejected from the ejection orifice to a recording medium,
wherein the ink storage portion comprises three or more storage parts divided independently of each other, and the three or more storage parts are arrayed in one predetermined direction,
wherein the aqueous ink comprises a magenta ink comprising a quinacridone pigment, and
wherein the magenta ink is stored in a corresponding one of the three or more storage parts arranged on an inner side.

2. The ink jet recording method according to claim 1, wherein the magenta ink further comprises a non-quinacridone pigment.

3. The ink jet recording method according to claim 2, wherein a content (% by mass) of the quinacridone pigment in the magenta ink is 1.5 times or more to 4.0 times or less in terms of a mass ratio with respect to a content (% by mass) of the non-quinacridone pigment.

4. The ink jet recording method according to claim 1, wherein the magenta ink further comprises a first water-soluble organic solvent having a relative dielectric constant of 20.0 or more to 30.0 or less, and a content (% by mass) of the first water-soluble organic solvent in the magenta ink is 10.00% by mass or more with respect to a total mass of the magenta ink.

5. The ink jet recording method according to claim 1, wherein the magenta ink further comprises an acetylene glycol-based surfactant.

6. The ink jet recording method according to claim 1, wherein the aqueous ink further comprises another ink other than the magenta ink, and a content (% by mass) of water in the magenta ink is lower than a content (% by mass) of water in the another ink.

7. The ink jet recording method according to claim 1, wherein the recording head has formed therein an ejection orifice array in which a plurality of the ejection orifices is arrayed in parallel to a longitudinal direction of the ink storage portion, and the ink storage portion has a ratio (A/B) of a length A in the longitudinal direction to a length B in a transverse direction orthogonal to the longitudinal direction, the ratio (A/B) being 2.0 times or more to 4.0 times or less.

8. The ink jet recording method according to claim 1, wherein the ink storage portion is replaced with another ink storage portion after the aqueous ink stored therein has been consumed.

9. The ink jet recording method according to claim 1, wherein the ink jet recording apparatus further comprises:
a second ink storage portion having a capacity larger than a capacity of the ink storage portion; and
a tube through which the aqueous ink flows between the second ink storage portion and the ink storage portion.

10. An ink jet recording apparatus comprising:
an aqueous ink comprising a pigment;
an ink storage portion which is configured to store the aqueous ink, and is formed from a thermoplastic resin composition comprising a filler material; and
a recording head to be bonded to the ink storage portion, the recording head having formed therein an ejection orifice configured to eject the aqueous ink supplied from the ink storage portion,
wherein the ink storage portion comprises three or more storage parts divided independently of each other, and the three or more storage parts are arrayed in one predetermined direction,
wherein the aqueous ink comprises a magenta ink comprising a quinacridone pigment, and
wherein the magenta ink is stored in a corresponding one of the three or more storage parts arranged on an inner side.
